(19) United States
(12) Patent Application Publication
(10) Pub. No.: US 2008/0308468 A1
(43) Pub. Date: Dec. 18, 2008

(54) Ore Beneficiation Flotation Processes

(75) Inventor: Daniel Martin Verster, Heidelberg (ZA)

Correspondence Address: THE FIRM OF HUESCHEN AND SAGE, SEVENTH FLOOR, KALAMAZOO BUILDING, 107 WEST MICHIGAN AVENUE, KALAMAZOO, MI, 49007, US

(73) Assignee: THE BOC GROUP INC., Murray Hill, NJ (US)

(21) Appl. No.: 11/885,979

(22) PCT Filed: Mar. 9, 2006
(86) PCT No.: PCT/IB06/50739

§ 371 Date: Mar. 10, 2008

(30) Foreign Application Priority Data
Mar. 11, 2005 (ZA) 2005/02092

(51) Int. Cl. B03D 1/02; C22B 3/00

(52) U.S. Cl. 209/166

(57) ABSTRACT

A method for optimizing an ore beneficiation flotation process through which a comminuted ore slurry, which includes a sulphide mineral, passes to produce a final flotation concentrate and a final flotation tail. The method comprises measuring oxygen demand in two or more locations in one or more of ore slurry, the final flotation concentrate and the final flotation tail, the locations being based on the potential for oxygen demand in the locations to be significantly different from each other, which would indicate that sulphide mineral particle oxidation can be manipulated. If sulphide mineral particle oxidation can be manipulated, flotation of the sulphide mineral is either promoted or suppressed (activated or deactivated) by manipulation of sulphide mineral particle oxidation depending on whether or not the sulphide mineral includes a valuable metal.

THIS INVENTION relates to ore beneficiation flotation processes. In particular, it relates to a method of obtaining useful information on an ore beneficiation flotation process, and to a method of optimizing an ore beneficiation flotation process.

Currently, a number of ore beneficiation flotation processes involve sulphide minerals. The sulphide minerals may or may not include valuable metals. Selected processes using sulphide minerals have the potential to significantly increase valuable metals recovery. Thus, the ability to characterise an ore beneficiation flotation process based on the behaviour of the sulphide minerals has the potential to improve the economics of the ore beneficiation flotation process.

According to one aspect of the invention, there is provided a method of optimizing an ore beneficiation flotation process through which a comminuted ore slurry, which includes a sulphide mineral, passes to produce a final flotation concentrate and a final flotation tail, the method including

measuring the oxygen demand in two or more locations in one or more of the ore slurry, the final flotation concentrate and the final flotation tail, the locations being based on the potential for the oxygen demand in the locations to be significantly different from each other, which would indicate that sulphide mineral particle oxidation can be manipulated; and

if sulphide mineral particle oxidation can be manipulated, either promoting or suppressing (activating or depressing) flotation of the sulphide mineral by manipulation of sulphide mineral particle oxidation depending on whether or not the sulphide mineral includes a valuable metal which it is desired to recover.

According to another aspect of the invention, there is provided a method of obtaining an indication of whether or not sulphide mineral particle surface oxidation is a significant mechanism in an ore beneficiation flotation process through which a comminuted ore slurry, which includes a sulphide mineral, passes to produce a final flotation concentrate and a final flotation tail, the method including

measuring the oxygen demand in two or more locations in one or more of the ore slurry, the final flotation concentrate and the final flotation tail, the locations being selected on the basis that there is potential for the oxygen demand in the locations to be significantly different from each other; and

comparing the oxygen demand measurements for significant differences which would indicate that sulphide mineral particle surface oxidation mechanisms are significant contributors to sulphide mineral floatability.

The invention extends to a method of determining the extent of sulphide mineral particle surface oxidation in an ore beneficiation flotation process through which a comminuted ore slurry, which includes a sulphide mineral, passes to produce a final flotation concentrate and a final flotation tail, the method including

measuring the oxygen demand in two or more locations in one or more of the ore slurry, the final flotation concentrate and the final flotation tail, the locations being selected on the basis that there is potential for the oxygen demand in the locations to be significantly different from each other; and

comparing the oxygen demand measurements.

By “manipulation of sulphide mineral particle oxidation” is meant that the sulphide mineral particle oxidation is enhanced, limited, prevented or reversed.

By “significantly different” is meant a difference by a factor of 4 or more in oxygen demand as measured by reactivity number (RN).

Measuring the oxygen demand in two or more locations in one or more of the ore slurry, final flotation concentrate and final flotation tail may include measuring the oxygen demand of the ore slurry feed, flotation concentrate and/or flotation tail of a flotation stage, e.g. a rougher, scavenger and/or cleaner flotation stage. Instead, or in addition, measuring the oxygen demand in two or more locations in one or more of the ore slurry, final flotation concentrate and final flotation tail may include measuring the oxygen demand in a discharge ore slurry stream from a main or first comminution stage and/or from a second or later comminution stage.

The method thus typically includes measuring oxygen demand in process streams such as ore slurries, flotation concentrates and/or flotation tailings in a plurality of positions in the ore beneficiation flotation process, to obtain a profile of the oxygen demand of the process. If the oxygen demand profile shows peaks and valleys, then it is an indication that sulphide particle surface oxidation mechanisms are significant contributors to sulphide mineral floatability, especially in respect of the high reactivity sulphides. Differences in oxygen reactivity of high and low reactivity sulphides enable selective manipulation of particle surfaces to promote or suppress floatability. Oxygen demand measurements (reactivity number measurements) characterise or quantify the degree of surface oxidation of sulphide mineral particles.

The method may include adjusting the measured oxygen demands to take into account the solids concentration and the iron concentration of the process stream at the locations where the oxygen demand was measured.

Typically, the measured oxygen demands are adjusted by multiplying the measured oxygen demands with a solids concentration adjustment factor and by an iron concentration adjustment factor.

The solids concentration adjustment factor may be a function of the ratio of a reference solids concentration and the actual solids concentration of the process stream. The iron concentration adjustment factor may be a function of the ratio of a reference iron concentration and actual iron concentration of the process stream, and the ratio of said reference solids concentration and actual solids concentration of the process stream.

The iron concentration adjustment factor may be the product of the ratio of the reference iron concentration and actual iron concentration and the ratio of the reference solids concentration and actual solids concentration.

The solids concentration adjustment factor may be the ratio of the reference solids concentration and actual solids concentration to a power of between 1.5 and 1.7.

The adjusted reactivity number for a process stream or sample may thus be calculated as follows:
RN_{adj}=RN×% S×% Fe
where
RN_{adj}=adjusted reactivity number
RN=reactivity number as measured
% S=solids concentration adjustment factor
% Fe=iron concentration adjustment factor
% S may be calculated as follows:

$$\% S = 0.5266 \times {( \frac{\% {Solids}_{ref}}{\% Solids} )}^{2} + 0.3946 ( \frac{\% {Solids}_{ref}}{\% Solids} ) + 0.0502$$

or approximated

$$\% S = {( \frac{\% {Solids}_{ref}}{\% Solids} )}^{1.6}$$

where
% Solids=actual solids concentration of the sample or process stream
% Solids_{ref}=reference solids concentration
% Fe may be calculated as follows:

$$\% Fe = ( \frac{\% {Iron}_{ref}}{\% Iron} ) / ( \frac{\% {Solids}_{ref}}{\% Solids} )$$

where
% Iron=actual iron concentration
% Iron_{ref}=reference iron concentration

The method may include adjusting one or more of the measured oxygen demands downwardly to take into account the oxygen demand of water present in the process stream. Taking the oxygen demand of water as typically being in the region of a reactivity number of about 1 to 2, the measured oxygen demand should be adjusted downwardly when the reactivity number of the water as a fraction of the reactivity number of a sample or process stream is more than about one third. The measured reactivity number may be adjusted downwardly by multiplying the measured reactivity number with a water correction factor which is between 0 and 1. A suitable water correction factor can be calculated using the following formula:
y=0.793x²−1.7865x+0.9937
where
y=water correction factor
x=water reactivity number as a fraction of the gross reactivity number of the sample or process stream.

Care must also be taken, when using an agitator to agitate a sample being analysed for oxygen demand, not to agitate the sample too vigorously, as this normally leads to oxygen loss to the atmosphere, thereby increasing the apparent oxygen demand of the sample. Typical agitator speeds for a laboratory scale agitator should thus be in the range of about 500 rpm to about 1000 rpm.

Measuring the oxygen demand of a sample or process stream may include determining the first order reaction rate constant for oxygen reactions in the sample or process stream. The first order reaction rate constant is typically derived from an oxygen concentration decay curve of an online sample.

Usually, a probe is used to measure the oxygen concentration. Probes with different response times are available and it is possible to determine a “probe reactivity number” as the probe also interacts with the sample or process stream and consumes oxygen. A probe with a “probe reactivity number” of at least about 1.5 times the actual sample or process stream reactivity number should be used, i.e. fast probes are preferred to slow probes.

Typical primary oxygen consumers in ore slurries, such as ore slurries from which copper, silver, gold, lead, zinc and/or platinum group metals are recovered, include sulphide minerals, metal cations such as ferrous iron, mild steel metallic iron from grinding media and, in bio-systems, bio-organisms. Secondary oxygen consumers include chemical reagents such as xanthate, cyanide, NaHS, etc.

It is believed that there is a correlation between slurry oxygen demand as measured in ore beneficiation flotation processes and primary sulphide mineral oxygen consumers. This correlation is affected by the sulphide mineral concentration, the sulphide mineral type and the degree of liberation of the sulphide mineral in the slurry. Sulphide minerals can be classified as low oxygen demand, medium oxygen demand and high oxygen demand sulphide minerals. Low oxygen demand sulphide minerals include chalcopyrite, bornite, chalcocite galena and sphalerite. Medium oxygen demand sulphide minerals include pentlandite and coarse grained pyrites such as arsenian pyrite. High oxygen demand sulphide minerals include pyrrhotite, arsenopyrite and fine grained pyrites such as amorphous arsenian pyrite, framboidal/microcrystalline arsenian pyrite and arsenian marcosite.

As far as sulphide mineral liberation is concerned, one would expect a more liberated sulphide mineral, e.g. a finely ground sulphide mineral, to increase the oxygen demand of a process stream. However, the matter is often complicated by surface oxidation of the sulphide mineral particles, with increased liberation of the sulphide mineral potentially leading to increased surface oxidation and thus a counteracting reduction in oxygen demand from the sulphide mineral.

As will be appreciated, an increase in the concentration of a high oxygen demand sulphide mineral will typically have a marked effect on the oxygen demand of a process stream. In contrast, for a low oxygen demand sulphide mineral, insignificant changes in slurry oxygen demand will typically be observed for varying sulphide mineral concentrations.

Promoting flotation of the sulphide mineral may include inhibiting or reversing oxidation of surfaces of the sulphide mineral. This may be achieved, for example, by using nitrogen-based flotation technologies. This may also include comminuting the ore in a non-oxidising atmosphere, e.g. under a nitrogen blanket.

Suppressing flotation of the sulphide mineral or sulphide minerals may include promoting oxidation of surfaces of the sulphide mineral, e.g. by using oxygen-based flotation technologies. Oxidation of surfaces of the sulphide mineral may lead to the formation of a hydrophilic layer, e.g. an Fe(OH₃) layer on the sulphide mineral, ensuring that particles of the sulphide mineral will collect in the flotation tails of a flotation process once a critical oxidation level has been exceeded. This critical surface oxidation level may coincide with a corresponding critical RN value.

The invention will now be described, by way of example, with reference to the accompanying diagrammatic drawings in which

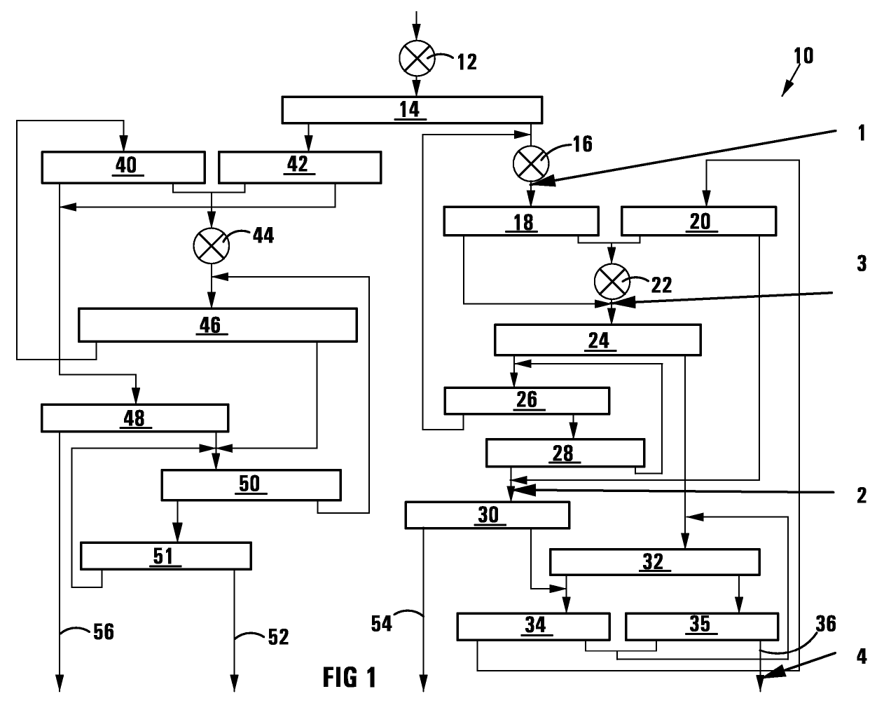

FIG. 1 shows an ore beneficiation flotation process;

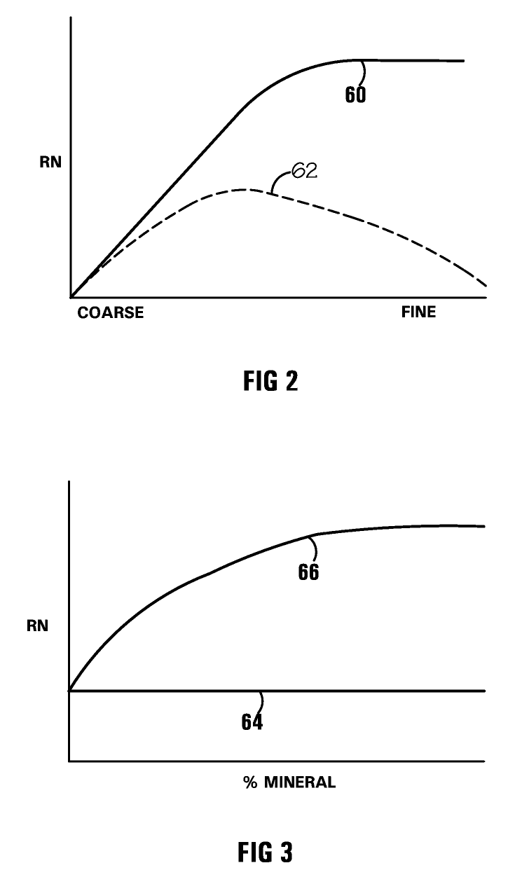

FIG. 2 shows graphs of the effect of pyrite/pyrrhotite surface oxidation and degree of liberation on reactivity number;

FIG. 3 shows graphs of the effect of sulphide mineral type on reactivity number;

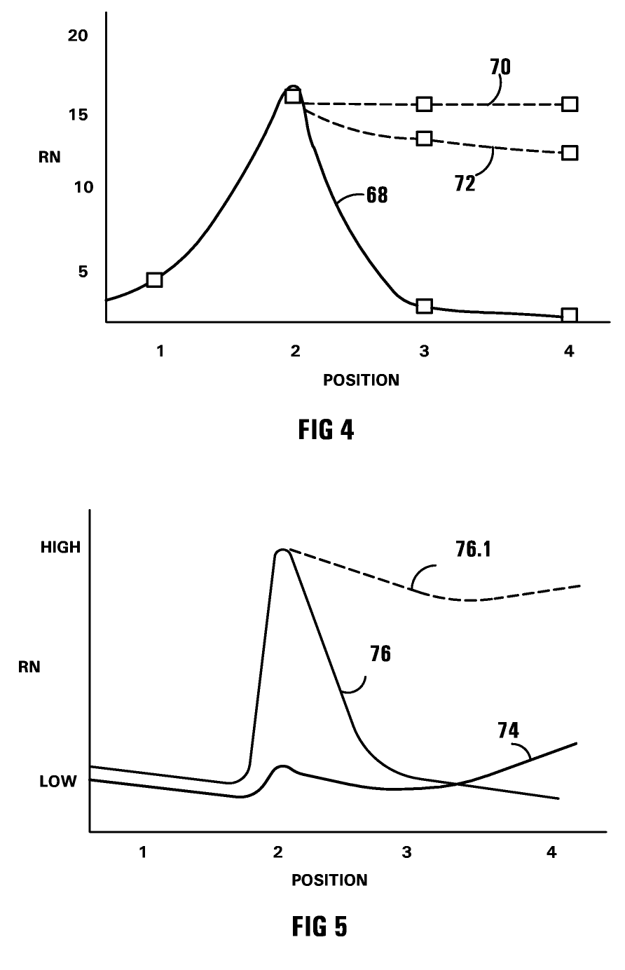

FIG. 4 shows a graph of the expected reactivity number profile of a flotation process treating ore which includes more reactive and less reactive pyrites/pyrrhotites;

FIG. 5 shows graphs of the expected reactivity number profiles of a flotation process treating various platinum group metal ores;

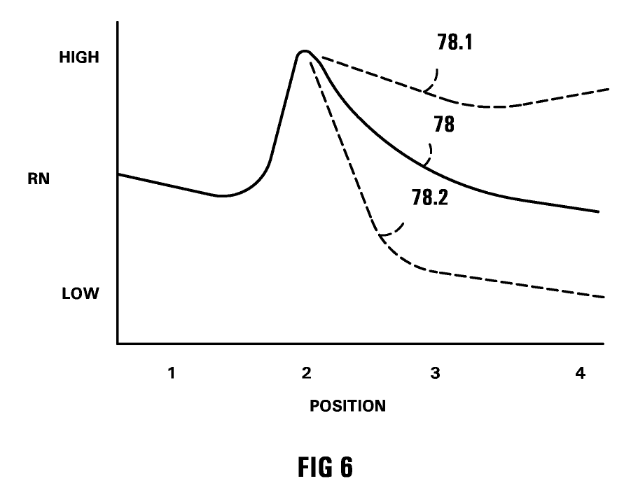

FIG. 6 shows graphs of the expected reactivity number profile of a pyrrhotitic nickel or lead/zinc ore slurry and the expected effects of nitrogen activation and oxygen depression on the reactivity number profile; and

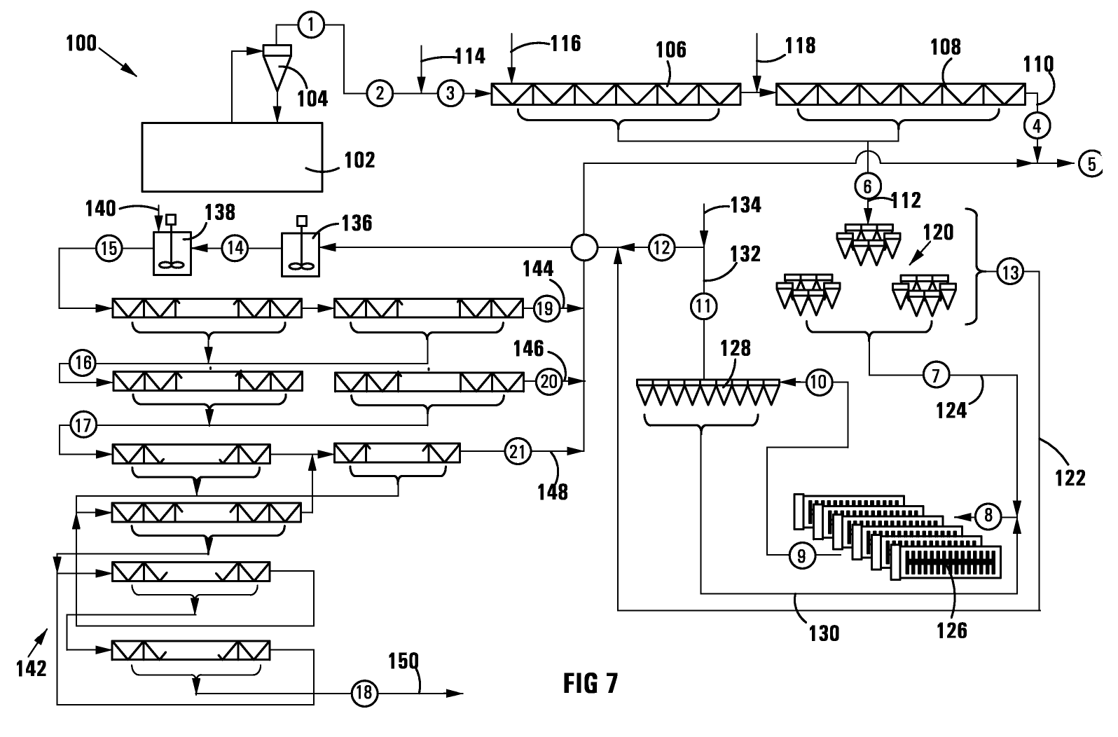

FIG. 7 shows another ore beneficiation flotation process.

Referring to FIG. 1 of the drawings, reference numeral 10 generally indicates an ore beneficiation flotation process, which is a typical flotation process for the beneficiation of an ore, which includes dolomite and sandstone and which produces mainly copper and silver.

The process 10 includes a plurality of rod mills 12, a spiral classifier 14 and a second mill 16 which is located in a dolomite side of the process 10. The dolomite side further includes two hydrocyclones 18, 20, a regrind mill 22 and a rougher scavenger flotation stage 24. The rougher scavenger flotation stage 24 is followed by two hydrocyclones 26 and 28 and a main flotation stage 30. A cleaner flotation stage 32 and two further cleaner flotation stages 34, 35 produce a final concentrate stream 36.

Although not relevant to the present invention, it is shown that a sandstone side of the process 10 includes two hydrocyclones 40 and 42 and a regrind mill 44. A rougher scavenger flotation stage 46 is located after the regrind mill 44. A main flotation stage 48 is followed by two cleaner flotation stages 50, 51 which produce a final concentrate stream 52.

In use, ore is crushed in the rod mills 12 and fed as an ore slurry to the spiral classifiers 14 where the ore is separated into a sandstone slurry and a dolomite slurry. The dolomite slurry is further comminuted in the second mill 16 with the slurry thereafter entering the hydrocyclone 18. Oversized ore particles from the hydrocyclone 18 are passed to the regrind mill 22, with slurry comprising ore particles less than 500 μm bypassing the regrind mill 22. From the regrind mill 22 and the hydrocyclone 18 the ore slurry passes to the rougher scavenger flotation stage 24 with an ore concentrate stream from the rougher scavenger flotation stage 24 passing to the cleaner flotation stage 32. Flotation tails from the rougher scavenger flotation stage 24 passes to the hydrocyclone 26. In the hydrocyclone 26, ore particles greater than 350 μm are separated and returned to the second mill 16, with smaller ore particles passing to the hydrocyclone 28. Oversized ore particles (>350 μm) are recycled from the hydrocyclone 28 to the hydrocyclone 26, with ore particles less than 350 μm entering the main flotation stage 30 where the ore slurry is subjected to flotation, producing an ore concentrate and a flotation tails stream 54. The ore concentrate stream joins a flotation tails stream from the cleaner flotation stage 32 before entering the cleaner flotation stage 34. Ore concentrate from the cleaner flotation stage 32 is passed to the cleaner flotation stage 35. Flotation tails from the cleaner flotation stage 34 is returned to the hydrocyclone 20 with flotation tails from the cleaner flotation stage 35 and ore concentrate from the cleaner flotation stage 34 being returned to the cleaner flotation stage 32.

For completeness, on the sandstone side of the process 10, the ore slurry enters the hydrocyclone 42 with oversized materials being separated in the hydrocyclone 42 and passed to the regrind mill 44. From the regrind mill 44, the ore slurry enters the rougher scavenger flotation stage 46. Flotation tails from the rougher scavenger flotation stage 46 are returned to the hydrocyclone 40 where oversized particles are separated and returned to the regrind mill 44. Particles with a diameter of less than 500 μm are fed from the hydrocyclone 40, together with fines from the hydrocyclone 42, to the main flotation stage 48. The main flotation stage 48 produces a flotation tails stream 56 and an ore concentrate. The ore concentrate from the main flotation stage 48 is joined by ore concentrate from the rougher scavenger flotation stage 46 before being subjected to further flotation in the cleaner flotation stage 50. Flotation tails from the cleaner flotation stage 50 is returned to the rougher scavenger flotation stage 46, with ore concentrate from the cleaner flotation stage 50 being passed on to the cleaner flotation stage 51. Flotation tails from the cleaner flotation stage 51 is recycled to the cleaner flotation stage 50, with the cleaner flotation stage 51 also producing the final concentrate stream 52.

The process 10 is an example of a typical ore beneficiation flotation process used to beneficiate an ore which may include sulphide minerals. It is believed that, at any point in the process 10, the oxygen demand of the process stream may be influenced by the sulphide minerals present in the process stream. It is further believed that the magnitude of the effect of the sulphide minerals is influenced by at least the concentration of the sulphide minerals in the process stream, the type of sulphide minerals present and the degree of liberation of the sulphide minerals present in the process stream, as well as the degree of particle surface oxidation of the reactive sulphides present. FIG. 2 shows a graph 60 of reactivity number (RN) of ore slurry as a function of the degree of sulphide mineral liberation, i.e. particle size. The reactivity number is the first order reaction rate constant for oxygen reactions, multiplied by 100 for convenience. This is typically derived by means of an oxygen decay curve of an online slurry sample. The graph 60 however does not take into account the effect of surface oxidation of the sulphide minerals (pyrite/pyrrhotite in the case of FIG. 2). If the effect of surface oxidation of the pyrite/pyrrhotite is taken into account, a graph such as the graph 62 shown in FIG. 2 is expected.

The effect of the sulphide mineral type and concentration on the reactivity number is illustrated in FIG. 3. As can be seen, an increase in the concentration of bornite and/or chalcocite (graph 64) in an ore slurry does not have a marked effect on the reactivity number, whereas there is a positive correlation between the concentration of pyrite/pyrrhotite in an ore slurry and the reactivity number of the ore slurry, as indicated by the graph 66. Low oxygen demand sulphide minerals such as bornite, chalcocite, chalcopyrite, galena and sphalerite do not materially influence the reactivity number of the ore slurry, whereas high oxygen demand sulphide minerals such as fine grained pyrites, pyrrhotite, arsenopyrite and arsenian marcasite have a marked effect on the reactivity number of a sulphide mineral containing ore slurry. Medium oxygen demand sulphide minerals such as pentlandite and coarse grained pyrites, e.g. arsenian pyrite are expected to produce a graph somewhere between the graphs 64 and 66 in FIG. 3.

The inventor has measured the oxygen demand of the ore slurry in the process 10, in four positions indicated by reference numerals 1, 2, 3 and 4 as shown in FIG. 1. The oxygen demand of the ore slurry as a function of location in the process 10, as represented by the reactivity number, is plotted in FIG. 4 and represented by the graph 68. As can be noticed, the reactivity number varies depending on where in the process 10 the oxygen demand was determined. The large variance in oxygen demand between the various locations in the process 10 was unexpected and is believed to be due to the effect of sulphide minerals present in the ore slurry passing through the process 10.

Surface oxidation of sulphide minerals, such as pyrite/pyrrhotite, can affect the flotation characteristics of the sulphide mineral particles. Typically, a hydrophilic Fe(OH)₃ layer forms on the sulphide mineral particle. This reduces the oxygen demand contribution from the sulphide mineral and, as a result of the hydrophilic effect of the Fe(OH)₃ layer, the sulphide mineral particle collects in the flotation tails, possibly once a critical surface oxidation level has been exceeded, as quantified by a critical RN value.

FIG. 4 shows two speculative graphs 70 and 72 which illustrate the expected effect on reactivity number if no or limited oxidation of sulphide minerals such as pyrites/pyrrhotites has taken place. It is thus expected that in the feed to the rougher scavenger flotation stage 24, and in the final concentrate stream 36, the reactivity number will remain high if sulphide minerals such as pyrites/pyrrhotites are oxidised to a very limited extent only.

Referring to FIG. 5 of the drawings, expected reactivity number as a function of sample position in a process, such as the process 10, for the beneficiation of a platinum group metal ore is shown for two ores with different sulphide minerals. The graph 74 shows the expected reactivity number profile for an ore slurry which is rich in pentlandite, i.e. a medium oxygen demand sulphide mineral. The graph 76 shows the expected reactivity number profile for an ore slurry which is rich in pyrrhotite, i.e. a high oxygen demand sulphide mineral. The striking difference between the expected reactivity numbers (oxygen demand) of the two ores, in the feed to the main flotation stage 30, is clearly illustrated by FIG. 5. FIG. 5 also shows a graph 76.1 which is the speculated reactivity number profile for a pyrrhotite rich platinum group metal ore slurry subjected to a flotation process, such as the process 10, but in which nitrogen is used to limit surface oxidation of the sulphide mineral particles. By using nitrogen, surface oxidation of the sulphide mineral particles can be inhibited, ensuring that the sulphide minerals remain a high oxygen consumer in the ore slurry and thereby promoting flotation of the sulphide mineral.

FIG. 6 shows an expected reactivity number profile for a process such as the process 10 in which a pyrrhotitic nickel or lead/zinc ore slurry is beneficiated. The expected reactivity number profile is indicated by the graph 78. FIG. 6 illustrates the potential for process optimization which now becomes possible by determining the reactivity number profile of an ore beneficiation flotation process and taking the inventor's observations into account. The oxygen demand of the ore slurry fed to the main flotation stage 30, for a pyrrhotitic ore slurry, is expected to be high as a result of the high degree of sulphide mineral liberation and the fact that pyrrhotite is a high oxygen demand sulphide mineral. Using normal air flotation, the oxygen demand of the final ore concentrate stream 36 is lower than the oxygen demand in the feed to the main flotation stage 30 but, as shown in FIG. 6, has the potential for being raised or lowered. If the pyrrhotite includes valuable metals, flotation of the pyrrhotite can be promoted by preventing, or reversing, reactivity number loss through the use of nitrogen-based flotation techniques and/or by applying other remedies to the process 10, e.g. by comminuting the ore under a nitrogen blanket. The optimization method of the invention thus allows one to focus remedies on areas of the process where the reactivity number loss, attributable to a lower oxygen demand from sulphide minerals, is the severest. The graph 78.1 thus shows the expected reactivity number profile for a process in which reactivity number loss is prevented or reversed. In contrast, the graph 78.2 shows the expected reactivity number profile for a process in which the reactivity number loss is enhanced, e.g. through the use of oxygen-based flotation techniques. This will typically be the desired outcome if the pyrrhotite is unwanted, i.e. if the pyrrhotite does not include a significant amount of valuable metals to be recovered.

Referring to FIG. 7 of the drawings, another ore beneficiation flotation process is generally indicated by reference numeral 100. The process 100 produces mainly zinc and lead.

The process 100 includes a milling station 102 followed by primary cyclones 104. Two rougher flotation cells 106, 108 produce a final tail 110 and a concentrate stream 112. A copper sulphate addition line 114 and two xanthate addition lines 116, 118 are provided.

The concentrate stream 112 is fed to pre-cyclones 120 producing a fines stream 122 and a coarse stream 124. The coarse stream 124 is fed to regrind mills 126, which are followed by a regrind cyclone 128 producing a coarse stream 130. The coarse stream 130 is then recycled to the regrind mills 126. A fines stream 132 from the regrind cyclone 128 joins the fines stream 122. A flotation depressant feed line 134 joins the fines stream 132.

The fines stream 132 feeds to two conditioners 136, 138. A copper sulphate and xanthate feed line 140 feeds into the second conditioner 138. From the conditioner 138, the ore slurry or fines stream is fed to a flotation stage 142 comprising a plurality of cleaner flotation cells. The flotation stage 142 produces three tailings streams 144, 146 and 148 which are combined and a final flotation concentrate 150.

The inventor has measured the oxygen demand of the process stream in the process 100, in twenty-one positions indicated by the numbers 1 to 21 in circles as shown in FIG. 7. Most of the measurements were taken on a particular day, although a few of the measurements were taken the day before. For many of the sampling points, two or more measurements were taken a few minutes apart with an average of the measurements then being calculated, to produce a single reactivity number for the process stream at that sampling position. For each sample, the solids concentration and the iron concentration were also determined. In order to determine if there is a correlation between the redox potential of the samples and the reactivity numbers of the samples, the redox potential of each sample was also measured. Each slurry sample had a volume of about 2 litres.

The effect of copper sulphate and xanthate and chemical flotation depressants on the reactivity number profile of the process 100 was also investigated by taking samples before and after these additives were added to the process 100.

The (average) reactivity number as measured for each sampling point was adjusted in accordance with the invention. The reactivity number as measured is determined by two variables, namely a “mass variable” which is determined by the solids concentration and the pyrite or iron concentration and a “pyrite surface variable” which depends on both the liberated pyrite surface area and the oxidation state of that surface area. The adjustment to the reactivity number as measured is required because the solids concentration and iron concentration normally show considerable variation in a flotation circuit. An adjusted reactivity number was calculated for each measured activity number by multiplying the measured reactivity number with a solids concentration adjustment factor and by an iron concentration adjustment factor. The solids concentration factor equalled the ratio of a reference solids concentration divided by the actual solids concentration, to the power 1.6. The iron concentration adjustment factor equalled the ratio of a reference iron concentration to the actual iron concentration of the sample, divided by the ratio of a reference solids concentration to the actual solids concentration of the sample. For the process 100, a 35% solids concentration was used as the reference value and a 7.3% iron concentration was used as the reference value.

The adjusted reactivity number (RN_{adj}) reflects only the “pyrite surface variable”, any “mass variable” having been substantially eliminated through application of the solids concentration and the iron concentration adjustment factors. RN_{adj} values depend only on the amount of liberated pyrite surface and the oxidation state of the pyrite surface, and can be expected to correlate closely with pyrite mineral floatability—RN_{adj} effectively becoming a pyrite flotation index.

By also measuring the pyrite particle size distribution, liberated pyrite mineral surface area can be approximately calculated and RN_{adj} suitably further adjusted to finally reflect pyrite mineral surface oxidation state only.

The following table provides information on the reactivity number as measured for each sampling position, the redox potential of the sample, the actual solids concentration of the sample, the solids concentration adjustment factor, the actual iron concentration of the sample, the iron concentration adjustment factor, the product of the solids concentration adjustment factor and the iron concentration adjustment factor (i.e. the total adjustment factor) and the adjusted reactivity number.

RN values adjusted to: 35% solids and 7.3% Fe

| | | | Redox | % Solids | | | | | | Total | |
|---|---|---|---|---|---|---|---|---|---|---|---|
| Position | | RN as | potential | of | Reference | % Solids | % Fe of | Reference | % Fe | adjustment | |
| number | Position | measured | (mV) | sample | % solids | factor | sample | % Fe | factor | factor | Adj [symbol] ed |
| 1 | Plant feed | 570 | −70 | 38 | 35 | 0.87 | 7.3 | 7.3 | 1.08 | 0.94 | [symbol] |
| 1 | Plant feed (day before) | 310 | 10 | 35 | 35 | 0.97 | 9.2 | 7.3 | 0.79 | 0.77 | 239 |
| 2 | Plant feed (before CuSO4 | 730 | −120 | 38 | 35 | 0.86 | 7.3 | 7.3 | 1.09 | 0.93 | 682 |
| | added) | | | | | | | | | | |
| 3 | Plant feed (after CuSO4 | 250 | 40 | 35 | 335 | 0.96 | 7.3 | 7.3 | 1.01 | 0.97 | 242 |
| | added) | | | | | | | | | | |
| 4 | Final tail | 10 | 115 | 13 | 35 | 4.93 | 8.2 | 7.3 | 0.33 | 1.63 | 16 |
| 5 | Tailings dam | 5 | 150 | 37 | 35 | 0.89 | 8.2 | 7.3 | 0.94 | 0.84 | 4 |
| 6 | Rougher concentrate | 5 | 30 | 27 | 35 | 1.42 | 10.5 | 7.3 | 0.54 | 0.77 | 4 |
| 7 | Precyclone underflow | 10 | 70 | 35 | 35 | 0.99 | 10.5 | 7.3 | 0.69 | 0.68 | 7 |
| 8 | Regrind mill feed | 90 | 40 | 28 | 35 | 1.33 | 10.5 | 7.3 | 0.57 | 0.75 | 68 |
| 9 | Regrind discharge | 1600 | −130 | 31 | 35 | 1.15 | 10.5 | 7.3 | 0.62 | 0.72 | 1144 |
| 10 | Regrind cyclone feed (day | 400 | −120 33 | 35 | 1.05 | 11.7 | 7.3 | 0.59 | 0.62 | 249 | |
| | before) | | | | | | | | | | |
| 11 | Regrind cyclone overflow | 490 | −130 | 27 | 35 | 1.45 | 11.7 | 7.3 | 0.48 | 0.70 | 341 |
| | (day before) | | | | | | | | | | |
| 12 | Regrind prod (after de- | 230 | 40 | 23 | 35 | 1.91 | 10.5 | 7.3 | 0.45 | 0.86 | 198 |
| | presants added) | | | | | | | | | | |
| 13 | Precyclone overflow | 10 | 10 | 16 | 35 | 3.53 | 10.5 | 7.3 | 0.31 | 1.10 | 11 |
| 14 | Combined cleaner feed | 30 | 60 | 17 | 35 | 2.96 | 10.5 | 7.3 | 0.35 | 1.03 | 31 |
| | (before Cu & X added) | | | | | | | | | | |
| 15 | Combined cleaner feed | 20 | 100 | 17 | 35 | 3.26 | 10.5 | 7.3 | 0.33 | 1.07 | 21 |
| | (after Cu & X added) | | | | | | | | | | |
| 16 | Cleaner 1 concentrate | 3 | 140 | 15 | 35 | 3.83 | 8.3 | 7.3 | 0.38 | 1.45 | [symbol] |
| 17 | Cleaner 2 concentrate | 1 | 120 | 20 | 35 | 2.41 | 6.2 | 7.3 | 0.66 | 1.60 | [symbol] |
| 18 | Final concentrate | 0 | 110 | 16 | 35 | 3.62 | 3.3 | 7.3 | 0.98 | 3.55 | [symbol] |
| 19 | Cleaner 1 tail | 20 | 30 | 16 | 35 | 3.59 | 12.5 | 7.3 | 0.26 | 0.93 | [symbol] |
| 20 | Cleaner 2 tail | 7 | 120 | 9 | 35 | 10.24 | 13.1 | 7.3 | 0.14 | 1.41 | [symbol] |
| 21 | Cleaner 3 tail | 4 | 110 | 7 | 35 | 13.50 | 15.4 | 7.3 | 0.10 | 1.36 | [symbol] |

By plotting the reactivity number as measured and the slurry redox potential against one another, for each sampling point, it was clear that there is no meaningful relationship between the reactivity number and slurry redox potential and one can therefore conclude that the reactivity number and the redox potential measure different slurry properties.

From the above table, it is clear that the adjusted reactivity number profile of the process 100 shows high peaks and deep valleys which is indicative of an ore beneficiation flotation process where pyrite plays a significant role, bearing in mind that surface oxidation of pyrite particles is an important mechanism of flotation. The relatively quick diagnostic method in accordance with the invention thus gives an operator an indication whether gases based flotation technologies may be of value for a specific ore beneficiation flotation process.

For the process 100, the following comments and recommendations can thus be made:

Plant feed reactivity number values are quite high despite P80 of around 50 μm (i.e. 80% of the particles passing through 50 μm). This indicates that pyrite particle surfaces are clean and flotable at this stage of the process 100. Mild steel media grinding will increase reactivity number, through direct contribution to reactivity number and/or through creation of a reducing environment which protects pyrite particles from surface oxidation. Plant feed reactivity number varies significantly over time by a factor of more than 100%. Feed from various sources and transition material will contribute to this and may cause problems with pyrite flotation in the rougher flotation cells 106, 108. An online reactivity number measurement system for the plant feed may be installed to make adjustments to variations in plant feed reactivity number.

The addition of copper sulphate through the copper sulphate addition line 114 reduces the reactivity number by at least 50% at position 3. This relates to the contribution of copper sulphate to pyrite flotation depression.

Although not shown in FIG. 7, the rougher flotation cells 106, 108 are preceded by additional flotation cells. A reactivity number of 240 at the feed to the rougher flotation cell 106 is considered to be too high. This high reactivity number predicts significant pyrite flotation in the earlier flotation cells. Thus, oxidising conditioning to a reactivity number value around 20 should fully depress pyrite flotation and reduce copper sulphate consumption. If pyrite/galena/sphalerite composite particles are common in the feed to the rougher flotation cells 106, 108, conditioning to an intermediate reactivity number between 240 and 20 may prove optimal. Again, an online reactivity number measurement system can be used to measure the reactivity number of the feed to the rougher flotation cells 106, 108 thereby to control the process 100.

The reactivity number of about 20 in the final tail 110 provides an indication as to the pyrite surface state required for depression of pyrite flotation. The massive liberation of fresh pyrite surfaces explains the sixteen-fold reactivity number increase over the regrind mills 126. Surface oxidation of the extremely reactive pyrite particles quickly reduces the reactivity number to around 340 at the overflow of the regrind cyclone 128 (sampling position 11).

The pyrite particle coating mechanism of flotation depressants, such as dextrin, is illustrated by an immediate reactivity drop from 340 to 200 between measurement positions 11 and 12. After conditioning in the first of the conditioners 138 (measurement position 14), the combined action of pyrite particle oxidation and coating has reduced the reactivity number to 30.

The addition of xanthate and copper sulphate in the second conditioner 138 has the net effect of further reducing the reactivity number to 20 at measurement position 15. Xanthate will generally increase reactivity number and copper sulphate will generally reduce reactivity number. This reactivity number of 20 demonstrates the extensive oxidation/coating actions required to depress the fine, highly reactive pyrite particles created in the regrind mills 126. It is to be borne in mind that a reactivity number of about 20 at a P80 of about 6 μm indicates much heavier surface oxidation/coating than the reactivity number of about 20 measured at P80 of about 50 μm at measurement position 4 in the final tail 110. This illustrates the importance of adjusting the reactivity number to take into account a combination of pyrite surface area and surface condition. The reactivity number profile indicates that there is a possibility that light oxidation preconditioning prior to the flotation stage 142 may be beneficial, mostly to reduce reagent consumption.

The reactivity number of the tailing streams 144, 146 and 148 are below 20, as could be expected. That pyrite particle surface oxidation is still taking place in the flotation cells is illustrated by the progressive reduction in the reactivity number from 4 to 2 to 0 in concentrate (measurement positions 15, 16 and 17) as well as a drop in reactivity number from 20 to 10 to 5 in the tailing streams (measurement positions 19, 20 and 21).

Measurement position 5 indicates the tailings dam. Oxidation even carries on in the tailings dam where a reactivity number of only 4 was measured.

Typical flotation recoveries of silver, for a process such as the process 10 in which copper is the main product, are of the order of about 85%. This means a loss of potential revenue for a large mining company which can easily be as high as US $40 million per year or higher. Where the more valuable metals form a larger portion of the recovered metals from the process, this loss may be enormous. By optimizing the flotation beneficiation process, using the method of the invention, substantial monetary benefits can thus be realised.

For both nitrogen and oxygen flotation techniques, there is the potential for synergies between the nitrogen and oxygen flotation techniques and chemical pyrrhotite activators and depressants respectively.

A reactivity number survey assists in determining suitable sites for application of O₂ based flotation technology (e.g. Actifloat™) or N₂ based flotation technologies (e.g. Cleanfloat™, Maxifloat™ or N₂Tec™). It also assists in optimising flotation circuits through application of gases based flotation technologies, reagent suite management, slurry feed management, and the like.

By determining the reactivity number profile of an ore beneficiation process, an additional benefit that can be used to advantage is that one can ensure that there is equivalence between laboratory bench flotation test work and actual plant conditions thereby to ensure that the laboratory bench work uses an ore slurry which has the same reactive particle surface oxidation characteristics as the actual plant ore slurry. In this way, unwanted influences in a laboratory, such as an increase in the reactivity number caused by milling with mild steel media in the laboratory under conditions of restricted air through flow, can be avoided or limited.

1-19. (canceled)

20. A method for optimizing an ore beneficiation flotation process through which a comminuted ore slurry, which includes a sulphide mineral, passes to produce a final flotation concentrate and a final flotation tail, the method comprising
measuring oxygen demand in two or more locations in one or more ore slurry, the final flotation concentrate and the final flotation tail, the locations being based on the potential for oxygen demand in the locations to be significantly different from each other, which would indicate that sulphide mineral particle oxidation can be manipulated; and
if sulphide mineral particle oxidation can be manipulated, either promoting or suppressing (activating or depressing) flotation of the sulphide mineral by manipulation of sulphide mineral particle oxidation depending on whether or not the sulphide mineral includes a valuable metal.

21. The method of claim 20, wherein measuring the oxygen demand comprises measuring the oxygen demand of the ore slurry feed, flotation concentrate and/or flotation tail of a flotation stage.

22. The method of claim 20, wherein measuring the oxygen demand comprises measuring the oxygen demand in a discharge ore slurry stream from a main or first comminution stage and/or from a second or later comminution stage.

23. The method of claim 20, wherein the measured oxygen demands are adjusted to take into account the solids concentration and the iron concentration of the process stream at the locations where the process stream oxygen demand was measured.

24. The method of claim 23, wherein the measured oxygen demands are adjusted by multiplying the measured oxygen demands with a solids concentration adjustment factor and by an iron concentration adjustment factor.

25. The method of claim 23, wherein the solids concentration adjustment factor is a function of the ratio of a reference solids concentration and the actual solids concentration of the process stream, and wherein the iron concentration adjustment factor is a function of the ratio of a reference iron concentration and actual iron concentration of the process stream, and the ratio of the reference solids concentration and actual solids concentration of the process stream.

26. The method of claim 25, wherein the iron concentration adjustment factor is the product of the ratio of the reference iron concentration and actual iron concentration and the ratio of the reference solids concentration and actual solids concentration.

27. The method of claim 25, wherein the solids concentration adjustment factor is the ratio of the reference solids concentration and actual solids concentration to a power of between 1.5 and 1.7.

28. The method of claim 20, wherein one or more of the measured oxygen demands are adjusted downwardly to take into account the oxygen demand of water present in the process stream.

29. A method of obtaining an indication of whether or not sulphide mineral particle surface oxidation is a significant mechanism in an ore beneficiation flotation process through which a comminuted ore slurry, which includes a sulphide mineral, passes to produce a final flotation concentrate and a final flotation tail, the method comprising
measuring oxygen demand in two or more locations in one or more ore slurry, the final flotation concentrate and the final flotation tail, the locations being selected on the basis that there is potential for oxygen demand in the locations to be significantly different from each other; and
comparing the oxygen demand measurements for significant differences which would indicate that sulphide mineral particle surface oxidation mechanisms are significant contributors to sulphide mineral floatability.

30. The method of claim 29, wherein measuring the oxygen demand comprises measuring the oxygen demand of the ore slurry feed, flotation concentrate and/or flotation tail of a flotation stage.

31. The method of claim 29, wherein measuring the oxygen demand comprises measuring the oxygen demand in a discharge ore slurry stream from a main or first comminution stage and/or from a second or later comminution stage.

32. The method of claim 29, wherein the measured oxygen demands are adjusted to take into account the solids concentration and the iron concentration of the process stream at the locations where the process stream oxygen demand was measured.

33. The method of claim 32, wherein the measured oxygen demands are adjusted by multiplying the measured oxygen demands with a solids concentration adjustment factor and by an iron concentration adjustment factor.

34. The method of claim 33, wherein the solids concentration adjustment factor is a function of the ratio of a reference solids concentration and the actual solids concentration of the process stream, and wherein the iron concentration adjustment factor is a function of the ratio of a reference iron concentration and actual iron concentration of the process stream, and the ratio of the reference solids concentration and actual solids concentration of the process stream.

35. The method of claim 33, wherein the iron concentration adjustment factor is the product of the ratio of the reference iron concentration and actual iron concentration and the ratio of the reference solids concentration and actual solids concentration.

36. The method of claim 34, wherein the solids concentration adjustment factor is the ratio of the reference solids concentration and actual solids concentration to a power of between 1.5 and 1.7.

37. The method of claim 29, wherein one or more of the measured oxygen demands are adjusted downwardly to take into account the oxygen demand of water present in the process stream.

38. A method of determining the extent of sulphide mineral particle surface oxidation in an ore beneficiation flotation process through which a comminuted ore slurry, which includes a sulphide mineral, passes to produce a final flotation concentrate and a final flotation tail, the method comprising
measuring oxygen demand in two or more locations in one or more ore slurry, the final flotation concentrate and the final flotation tail, the locations being selected on the basis that there is potential for the oxygen demand in the locations to be significantly different from each other; and
comparing the oxygen demand measurements.
